(19) United States
(12) Patent Application Publication
(10) Pub. No.: US 2015/0360726 A1
(43) Pub. Date: Dec. 17, 2015

(54) VEHICLE FRONT PORTION STRUCTURE

(71) Applicant: TOYOTA JIDOSHA KABUSHIKI KAISHA, Toyota-shi (JP)

(72) Inventor: Hirofumi YUGE, Toyota-shi (JP)

(21) Appl. No.: 14/727,078

(22) Filed: Jun. 1, 2015

(30) Foreign Application Priority Data
Jun. 17, 2014 (JP) 2014-124473

(51) Int. Cl. B62D 25/08

(52) U.S. Cl. CPC B62D 25/085; B62D 25/088

(57) ABSTRACT

A vehicle front portion structure including: front side members disposed along a vehicle body longitudinal direction, whose vehicle body front portion sides are disposed at a higher position than vehicle body rear portion sides thereof; a sub-frame that is disposed at a vehicle body lower side of the front side members at the vehicle body front portion sides of the front side members, due to front side fixed portions of the sub-frame being mounted to the vehicle body front portion sides of the front side members, and rear side fixed portions of the sub-frame being mounted to the vehicle body rear portion sides of the front side members; mount supporting portions provided at midway portions in the vehicle body longitudinal direction of the sub-frame, to which engine mounts are mounted; and connecting members that connect the mount supporting portions with the front side members.

### CROSS-REFERENCE TO RELATED APPLICATION

This application is based on and claims priority under 35 USC 119 from Japanese Patent Application No. 2014-124473 filed on Jun. 17, 2014, the disclosure of which is incorporated by reference herein.

### BACKGROUND

1. Technical Field

The present invention relates to a vehicle front portion structure.

2. Related Art

There have conventionally been known structures in which a vehicle front portion structure, that has a sub-frame that supports the engine at the vehicle body lower side of front side members, has connecting members that connect vehicle body longitudinal direction intermediate portions of the sub-frame and the front side members in the vehicle body vertical direction, in a side view seen from the vehicle transverse direction (see, for example, Japanese Patent Application Laid-Open (JP-A) Nos. 2008-174179 and 2005-047363).

At the sub-frame, vibration in the vehicle body vertical direction is excited due to the engine vibrating. However, in the above-described structures, the connecting members are not connected to the regions where the amount of deformation (the amplitude) of the sub-frame is the greatest, and therefore, vibration, in the vehicle body vertical direction, of the sub-frame cannot be suppressed effectively. In this way, there is still room for improvement in structures that effectively suppress vibration, in the vehicle body vertical direction, of a sub-frame.

### SUMMARY

Thus, an object of the present invention is to provide a vehicle front portion structure that can effectively suppress vibration, in the vehicle body vertical direction, of a sub-frame.

A first aspect of the present invention provides a vehicle front portion structure including:

front side members that are disposed along a vehicle body longitudinal direction, and whose vehicle body front portion sides are disposed at a higher position than vehicle body rear portion sides thereof;

a sub-frame that is disposed at a vehicle body lower side of the front side members at the vehicle body front portion sides of the front side members, due to front side fixed portions of the sub-frame being mounted to the vehicle body front portion sides of the front side members, and rear side fixed portions of the sub-frame being mounted to the vehicle body rear portion sides of the front side members;

mount supporting portions that are provided at midway portions in the vehicle body longitudinal direction of the sub-frame, and to which engine mounts that support an engine are mounted; and

connecting members that connect the mount supporting portions with the front side members.

In accordance with the vehicle front portion structure of the first aspect of the present invention, the mount supporting portion of the sub-frame and the front side member are connected by the connecting member. Here, due to the engine vibrating, load is inputted directly to the mount supporting portion to which the engine mount, that supports the engine, is mounted. Namely, the amplitude of the vibration in the vehicle body vertical direction that is excited at the sub-frame is greatest in a vicinity of the mount supporting portion to which the load is inputted. Accordingly, by connecting this mount supporting portion and the front side member by the connecting member, vibration of the sub-frame in the vehicle body vertical direction is suppressed effectively.

A second aspect of the present invention provides the vehicle front portion structure of the first aspect, wherein, in a side view seen from a vehicle transverse direction, each connecting member extends along a direction orthogonal to an imaginary straight line that connects the front side fixed portions and the rear side fixed portions.

In accordance with the vehicle front portion structure of the second aspect of the present invention, the connecting member extends along a direction orthogonal to an imaginary straight line that connects the front side fixed portion and the rear side fixed portion, in a side view seen from the vehicle transverse direction. Namely, as seen in a side view, the connecting member is disposed along the orientation of the vibration that is excited at the sub-frame. Accordingly, vibration of the sub-frame in the vehicle body vertical direction is suppressed more effectively. Note that “orthogonal” in the present invention also includes substantially orthogonal that is slightly offset from exactly orthogonal.

A third aspect of the present invention provides the vehicle front portion structure of the first aspect, wherein the each connecting member includes a main body portion that is formed in a flat plate shape, and a bead portion that is convex in cross-section is formed at the main body portion.

In accordance with the vehicle front portion structure of the third aspect of the present invention, the connecting member has the main body portion that is formed in a flat plate shape, and the bead portion that is convex in cross-section is formed at this main body portion. Accordingly, the rigidity and strength of the main body portion at the connecting member are improved by a simple structure, and vibration of the sub-frame in the vehicle body vertical direction is suppressed more effectively.

A fourth aspect of the present invention provides the vehicle front portion structure of the third aspect, wherein, in a side view seen from a vehicle transverse direction, the bead portion extends along a direction orthogonal to an imaginary straight line that connects the front side fixed portion and the rear side fixed portion.

In accordance with the vehicle front portion structure of the fourth aspect of the present invention, the bead portion is formed along a direction orthogonal to an imaginary straight line that connects the front side fixed portion and the rear side fixed portion, in a side view seen from the vehicle transverse direction. Namely, as seen in a side view, the bead portion is formed along the orientation of the vibration that is excited at the sub-frame. Accordingly, vibration of the sub-frame in the vehicle body vertical direction is suppressed more effectively. Note that “orthogonal” in the present invention also includes substantially orthogonal that is slightly offset from exactly orthogonal.

In accordance with the vehicle front portion structure of the first aspect of the present invention, vibration of the sub-frame in the vehicle body vertical direction can be suppressed effectively.

In accordance with the vehicle front portion structure of the second aspect of the present invention, vibration of the sub-frame in the vehicle body vertical direction can be suppressed more effectively.

In accordance with the vehicle front portion structure of the third aspect of the present invention, vibration of the sub-frame in the vehicle body vertical direction can be suppressed more effectively by a simple structure.

In accordance with the vehicle front portion structure of the fourth aspect of the present invention, vibration of the sub-frame in the vehicle body vertical direction can be suppressed even more effectively by a simple structure.

### BRIEF DESCRIPTION OF THE DRAWINGS

Exemplary embodiments of the present invention will be described in detail based on the following figures, wherein:

FIG. 1 is a perspective view showing a vehicle front portion structure relating to a first embodiment;

FIG. 2 is a side view showing the vehicle front portion structure relating to the first embodiment;

FIG. 3 is an enlarged front view showing, in a partial cross-section, the vehicle front portion structure relating to the first embodiment;

FIG. 4A and FIG. 4B are perspective views showing a fastening structure of a connecting member;

FIG. 5 is a perspective view showing the fastening structure of the connecting member;

FIG. 6 is a side view showing a vehicle front portion structure relating to a second embodiment; and

FIG. 7 is a side view showing a vehicle front portion structure relating to a comparative example.

### DETAILED DESCRIPTION

Embodiments relating to the present invention are described in detail hereinafter on the basis of the drawings. Note that, for convenience of explanation, arrow UP that is shown appropriately in the respective drawings indicates the vehicle body upward direction, arrow FR indicates the vehicle body forward direction, and arrow LH indicates the vehicle body leftward direction. Further, in the following explanation, when vertical, longitudinal and left-right directions are used, they mean the vertical of the vehicle body vertical direction, the longitudinal of the vehicle body longitudinal direction, and the left and right of the vehicle body left-right direction (the vehicle transverse direction), unless otherwise stated. Moreover, although the left side of a vehicle 12 is illustrated in the respective drawings, the vehicle 12 has left-right symmetry, and the right side thereof is similar to the left side.

### First Embodiment

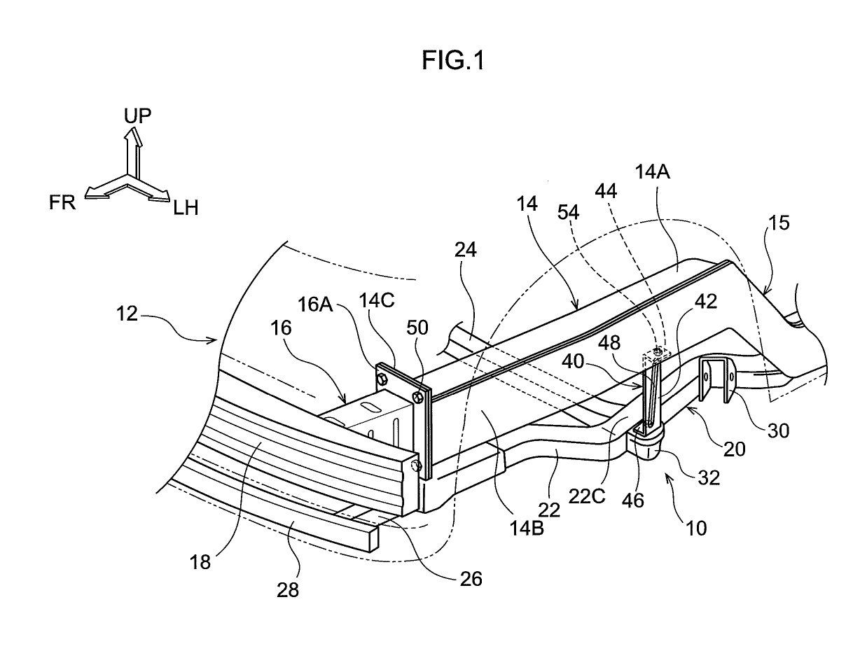

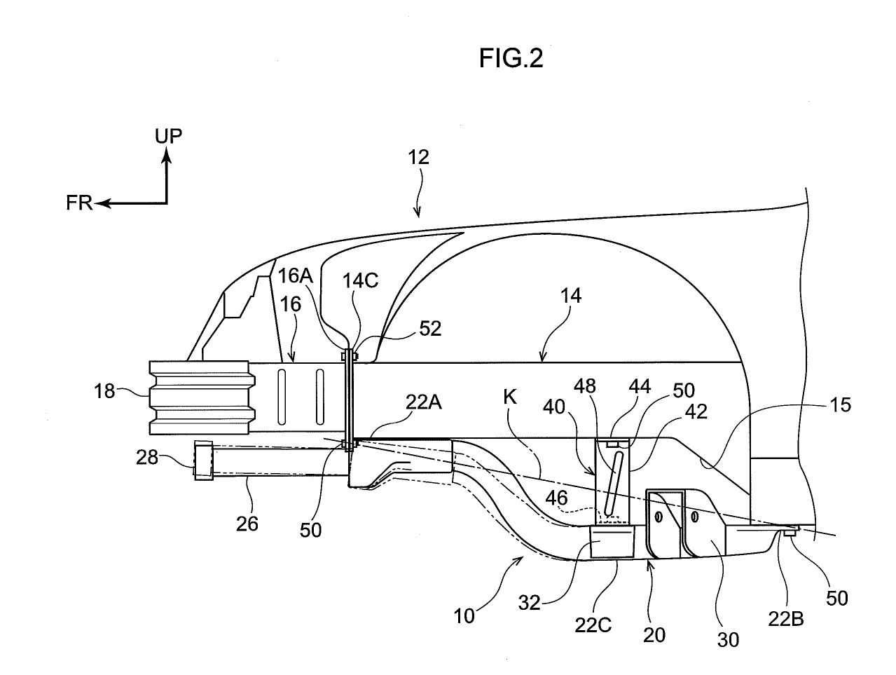

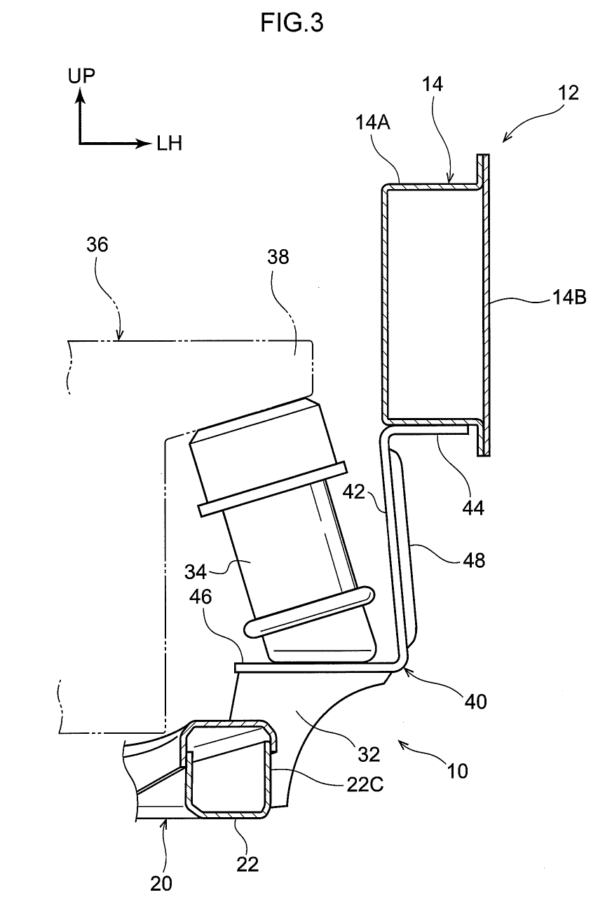

A vehicle front portion structure 10 relating to a first embodiment is described first. As shown in FIG. 1 and FIG. 2, a pair of front side members 14 that extend along the vehicle body longitudinal direction are provided at the front portion side of the vehicle 12, so as to be apart from one another by a predetermined interval to the left and the right. As shown in FIG. 1 and FIG. 3, each of the front side members 14 is formed in a rectangular closed cross-sectional shape due to an inner panel 14A, that is hat-shaped in cross-section, and an outer panel 14B, that is flat plate shaped, being joined together.

As shown in FIG. 1 and FIG. 2, a crash box 16 that has a rectangular closed cross-sectional shape is provided at the front end portion of each of the front side members 14. In detail, a flange portion 14C that is rectangular frame shaped is formed integrally at the front end portion of the front side member 14. A flange portion 16A, that is rectangular frame shaped and is the same size as the flange portion 14C, is formed at the rear end portion of the crash box 16. Further, hole portions (not illustrated) for fastening of bolts are formed in the flange portions 14C, 16A respectively.

Accordingly, due to the respective flange portions 14C and flange portions 16A being superposed together, and bolts 50 being inserted through the respective hole portions thereof that communicate with one another, and the bolts 50 being screwed-together with nuts 52, the crash boxes 16 are mounted coaxially to the front end portions of the front side members 14 respectively. Further, a front bumper reinforcement 18, that has a rectangular closed cross-sectional shape and extends in the vehicle transverse direction, spans between the front end portions of the respective crash boxes 16.

Further, an inclined portion (kick-up portion) 15, that allows the vehicle body front portion side of the front side member 14 to be disposed at a position that is higher (a higher position) than the vehicle body rear portion side thereof, is formed at each of the front side members 14. A suspension member 20 that serves as a sub-frame is disposed at the vehicle body front side of each inclined portion 15, i.e., at the vehicle body lower side of the vehicle body front side portion of the front side member 14 that includes the inclined portion 15.

As seen in plan view, the suspension member 20 is formed in a substantial “U” shape whose vehicle body front side is open. Midway portions 22C in the vehicle body longitudinal direction of a pair of left and right side frames 22, that extend in the vehicle body longitudinal direction, are connected by a cross frame 24 that extends in the vehicle transverse direction. Further, rear side fixed portions 22B, that are provided at the rear end portions of the respective side frames 22 (at the left and right both sides of the suspension member 20), are fastened and fixed by the bolts 50 to the lower end portions of the respective inclined portions 15 (the bottom walls of the vehicle body rear side portions of the front side members 14).

Further, the portion, that is further toward the vehicle body front side than the midway portion 22C, of each side frame 22 is bendingly molded toward the vehicle body upper front side. A front side fixed portion 22A, that is provided at the front end portion of each side frame 22, is fastened and fixed by bolts (not illustrated) to the front end portions of the front side members 14 (the bottom walls of the vehicle body front side portions of the front side members 14 at the rear sides of the flange portions 14C). Due thereto, the suspension member 20 is supported in a state of hanging-down from the respective front side members 14.

A crash box 26 is provided at the front end portion of each side frame 22 (at the vehicle body front side of the front side fixed portion 22A). A front lower bumper reinforcement 28, that has a rectangular closed cross-sectional shape and that extends in the vehicle transverse direction, spans between the front end portions of the respective crash boxes 26. Further, a bracket 30, that is for mounting a lower arm that is unillustrated and that structures a suspension, is provided at a portion of each side frame 22 which portion is further toward the vehicle body rear side than the midway portion 22C.

A mount supporting portion 32, to which an engine mount 34 that is described later is mounted, is provided at the outer side wall of the midway portion 22C of each side frame 22. As shown in FIG. 3, an engine 36 is disposed at the vehicle body upper side of the suspension member 20. Overhang portions 38, that are formed at the left and right both sides of the engine 36 and jut-out toward the vehicle transverse direction outer sides, are supported from the vehicle body lower side by the engine mounts 34 respectively.

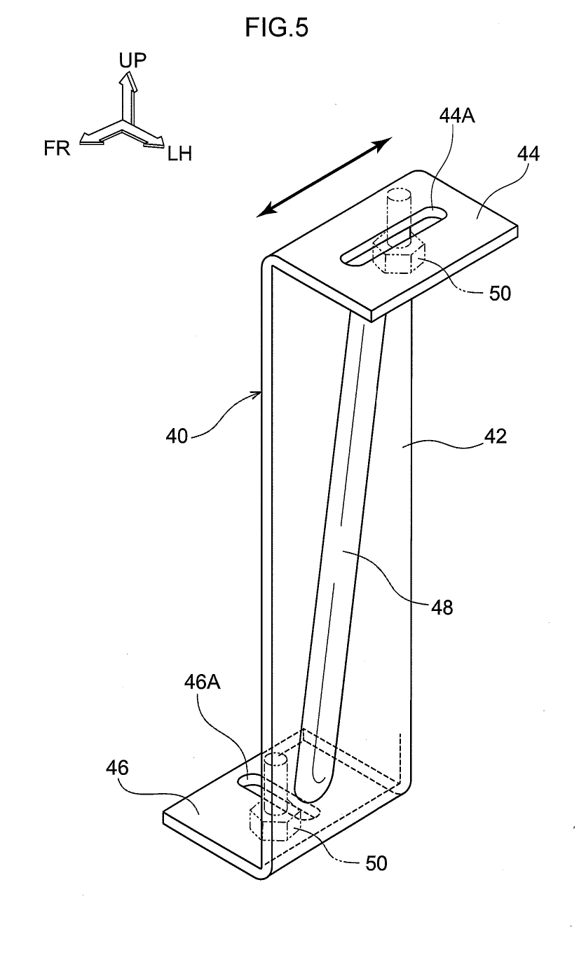

Each of the engine mounts 34 is structured to include an elastic body of rubber or the like that is formed in a cylindrical shape. A nut portion (not shown) is formed at the lower end portion of the engine mount 34. Further, a hole portion (not shown) for bolt fastening is formed in the mount supporting portion 32. Accordingly, the engine mounts 34 are fastened and fixed to the mount supporting portions 32 respectively, due to the bolts 50 (see FIG. 5) being inserted-through the hole portions of the mount supporting portions 32 from the vehicle body lower side and being screwed-together with nut portions.

Note that it suffices for the mount supporting portion 32 to be formed in a shape that has rigidity and strength that make it possible for the mounting supporting portion 32 to support the engine mount from the vehicle body lower side, and the shape thereof is not particularly limited. However, the respective mount supporting portions 32 are disposed further toward the vehicle transverse direction inner side than the respective front side members 14.

As shown in FIG. 1 through FIG. 3, the mount supporting portion 32 and the front side member 14 are connected by a connecting member 40. The connecting member 40 has a main body portion 42 that is flat plate shaped and extends in the vehicle body vertical direction, an upper connecting portion 44 that is formed at the upper end portion of the main body portion 42, and a lower connecting portion 46 that is formed at the lower end portion of the main body portion 42.

The lower connecting portion 46 is formed by the lower portion side of the main body portion 42 being bent toward the vehicle transverse direction inner side, and is mounted by fastening by a bolt to the mount supporting portion 32 together with the engine mount 34. Namely, a hole portion 46A for bolt fastening (see FIG. 5) is formed in the lower connecting portion 46. The mount supporting portion 32, the engine mount 34 and the lower connecting portion 46 are fastened together due to the lower connecting portion 46 being nipped between the mount supporting portion 32 and the engine mount 34, and the bolt 50 (see FIG. 5) being inserted through this hole portion 46A as well and being screwed-together with a nut portion.

The upper connecting portion 44 is formed by the upper portion side of the main body portion 42 being bent toward the vehicle transverse direction outer side, and is mounted to the bottom wall of the vehicle body front side portion of the front side member 14 by fastening by a bolt (by the bolt 50 being screwed from the vehicle body lower side). Accordingly, a hole portion 44A for bolt fastening is formed in the upper connecting portion 44, and a hole portion for bolt fastening (not shown) is formed also in the bottom wall of the front side member 14. Further, a weld nut 54 (see FIG. 1) is provided coaxially with these hole portions at the bottom wall of the front side member 14.

A bead portion 48 for reinforcement that is convex in cross-section is formed at the main body portion 42. As shown in FIG. 2, in a side view seen from the vehicle transverse direction, the bead portion 48 is formed along a direction that is substantially orthogonal to imaginary straight line K that connects the front side fixed portion 22A and the rear side fixed portion 22B of the side frame 22.

Note that, although the illustrated bead portion 48 is formed so as to be convex toward the vehicle transverse direction outer side, the bead portion 48 may be formed so as to be convex toward the vehicle transverse direction inner side. Further, the both side portions (the side edge portions at the vehicle body front side and the vehicle body rear side) of the main body portion 42 may be bent toward the vehicle transverse direction inner side or outer side so as to form flange portions (not illustrated), so as to further reinforce the main body portion 42.

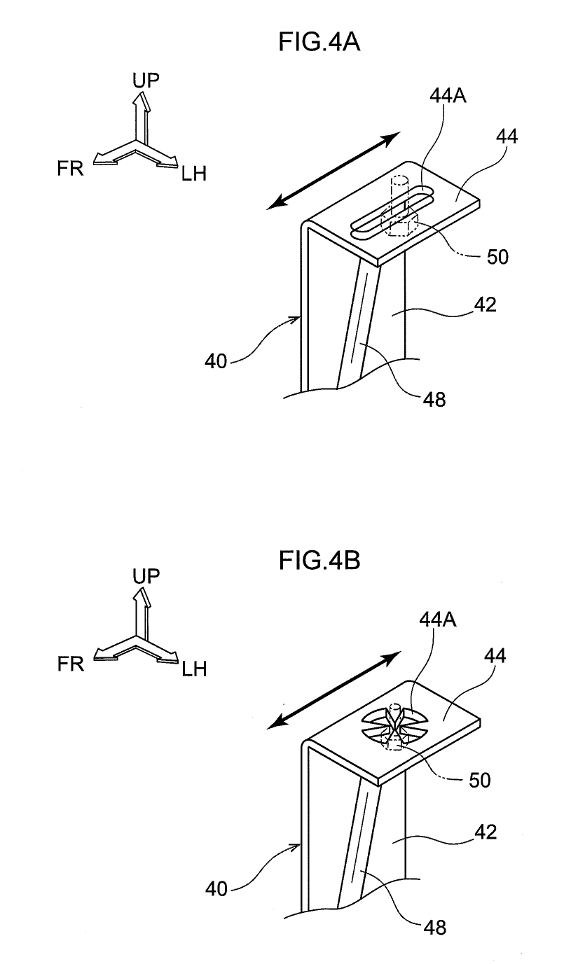

As shown in FIG. 4A, the hole portion 44A for fastening that is formed in the upper connecting portion 44 is a long hole that is long in the vehicle body longitudinal direction. The bolt 50 is inserted, from the vehicle body lower side, through the length direction central portion of this hole portion 44A that is a long hole, and the upper connecting portion 44 is fastened to the bottom wall of the front side member 14.

Due thereto, when a relatively large load is applied from the vehicle body front side at the time when the vehicle 12 is involved in a front collision (a full overlap collision or an offset collision) or the like, the connecting member 40 does not impede relative movement, in the vehicle body longitudinal direction, between the front side member 14 and the suspension member 20.

Namely, the connecting member 40 can, together with the front side member 14 and the suspension member 20, move in the vehicle body longitudinal direction. Note that, not only at the upper connecting portion 44, but also the hole portion 46A for fastening that is formed in the lower connecting portion 46 may be made to be a long hole that is long in the vehicle body longitudinal direction. Namely, it suffices for either one of the hole portion 44A of the upper connecting portion 44 and the hole portion 46A of the lower connecting portion 46 to be a long hole that is long in the vehicle body longitudinal direction.

Further, the hole portion 44A of the upper connecting portion 44 (or the hole portion 46A of the lower connecting portion 46) may be made to be tooth-shaped as shown in FIG. 4B. In this case, it is desirable that the hole portion 44A be made to be a shape in which the teeth do not project-out along the vehicle body longitudinal direction, so that the connecting member 40 will not impede relative movement, in the vehicle body longitudinal direction, of the front side member 14 and the suspension member 20.

Moreover, as shown in FIG. 5, the hole portion 44A for fastening, that is formed in the upper connecting portion 44, may be made to be a long hole that is long in the vehicle body longitudinal direction, and the hole portion 46A for fastening, that is formed in the lower connecting portion 46, may be made to be a long hole that is long in the vehicle transverse direction. With such a structure, operation and effects that are similar to those described above can be obtained by the hole portion 44A, and in addition, at the time of assembling the connecting member 40 to the front side member 14 and the suspension member 20, errors in the assembly positions in the vehicle transverse direction can be absorbed by the hole portion 46A. Accordingly, assembly of the connecting member 40 can be made easy.

Note that, although not illustrated, the hole portion 44A for fastening, that is formed in the upper connecting portion 44, may be made to be a long hole that is long in the vehicle transverse direction, and the hole portion 46A for fastening, that is formed in the lower connecting portion 46, may be made to be a long hole that is long in the vehicle body longitudinal direction. In this case, operation and effects that are similar to those described above can be obtained by the hole portion 46A, and in addition, at the time of assembling the connecting member 40 to the front side member 14 and the suspension member 20, errors in the assembly positions in the vehicle transverse direction can be absorbed by the hole portion 44A.

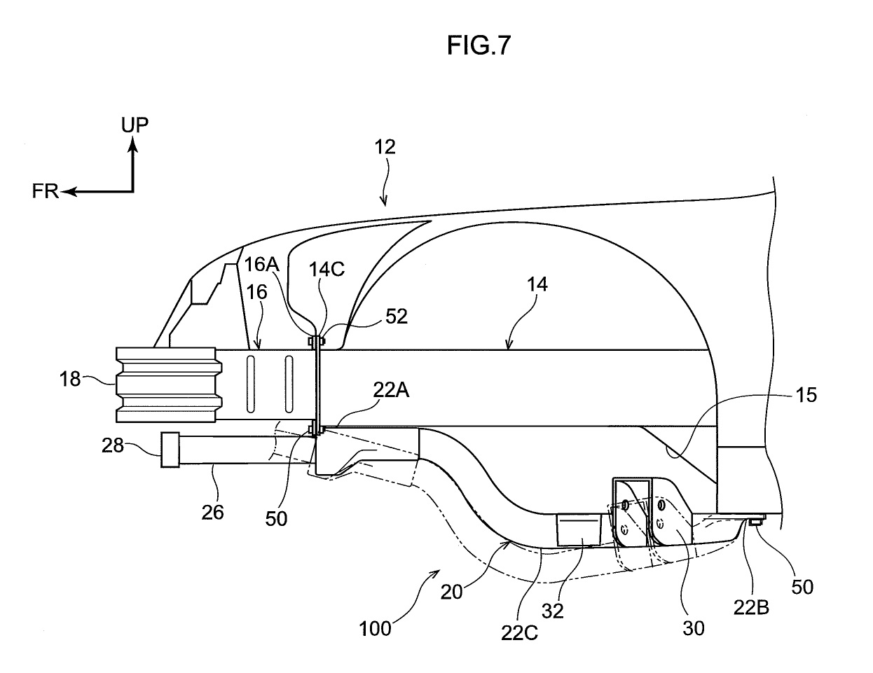

Operation at the vehicle front portion structure 10 relating to the first embodiment that is structured as described above is described next. Note that, in FIG. 2 and FIG. 7, the state at the time when the side frame 22 (the suspension member 20) has deformed (vibrated) the most is shown by the imaginary lines. However, in order to facilitate understanding of the present embodiment, this state is drawn in an exaggerated manner.

First, a vehicle front portion structure 100, that relates to a comparative example and that is not provided with the connecting member 40 relating to the present embodiment, is described. When load is inputted directly to the mount supporting portion 32 via the engine mount 34 due to the engine 36 vibrating, as shown in FIG. 7, vibration that is directed in the substantially vertical direction (the direction substantially orthogonal to the imaginary straight line K as seen in a side view) is excited at the side frame 22 of the suspension member.

Namely, in the state in which the front side fixed portion 22A and the rear side fixed portion 22B are fixed to the front side member 14, a vicinity of the midway portion 22C, that includes the mount supporting portion 32, of the side frame 22 vibrates in the substantially vertical direction (the direction substantially orthogonal to the imaginary straight line K as seen in a side view). This vicinity of the midway portion 22C that includes the mount supporting portion 32 is the portion that is the antinode of the vibration in low-order resonance of the side frame 22 (the suspension member 20) (i.e., is the portion where the amount of deformation (the amplitude) is the largest).

On the other hand, at the vehicle front portion structure 10 relating to the present embodiment, this mount supporting portion 32 and the front side member 14 are connected by the connecting member 40. Accordingly, even if load is inputted directly to the mount supporting portion 32 via the engine mount 34 due to the engine 36 vibrating, as shown in FIG. 2, vibration in the substantially vertical direction (the direction substantially orthogonal to the imaginary straight line K as seen in a side view), that is excited at the side frame 22, is reduced more than in the vehicle front portion structure 100 relating to the comparative example.

Namely, in the vehicle front portion structure 100 relating to the comparative example, the vicinity of the midway portion 22C, that includes the mount supporting portion 32, of the side frame 22 vibrates in the substantially vertical direction in a state in which the front side fixed portion 22A and the rear side fixed portion 22B are fixed to the front side member 14. In contrast, in the vehicle front portion structure 10 relating to the present embodiment, the portion, that is further toward the front side than the midway portion 22C, of the side frame 22 vibrates in the substantially vertical direction in the state in which the front side fixed portion 22A and the rear side fixed portion 22B and the mount supporting portion 32 are fixed to the front side member 14. Accordingly, the amplitude at the vehicle front portion structure 10 relating to the present embodiment is smaller than the amplitude at the vehicle front portion structure 100 relating to the comparative example.

In this way, in accordance with the vehicle front portion structure 10 relating to the present embodiment, vibration in the substantially vertical direction that is excited at the side frame 22 (the suspension member 20) can be suppressed. Moreover, because the bead portion 48 is formed at the connecting member 40 (the main body portion 42), the rigidity and strength of the connecting member 40 (the main body portion 42) can be improved by a simple structure. Accordingly, the suspension member 20 (the side frame 22) can be reinforced by the connecting member 40, and this vibration can be suppressed more effectively.

Further, as seen in a side view, this bead portion 48 is formed along a direction substantially orthogonal to the imaginary straight line K that connects the front side fixed portion 22A and the rear side fixed portion 22B. Namely, as seen in a side view, the bead portion 48 is formed along the orientation of the vibration that is excited at the side frame 22 (the suspension member 20).

Accordingly, the rigidity and the strength of the connecting member 40 (the main body portion 42), in the direction substantially orthogonal to the imaginary straight line K as seen in a side view, can be improved even more, and vibration of the side frame 22 (the suspension member 20) in that direction can be suppressed more effectively. Accordingly, noise, that is generated within the vehicle cabin due to this vibration, can be suppressed.

### Second Embodiment

A vehicle front portion structure 10 relating to a second embodiment is described next. Note that regions that are equivalent to those of the above-described first embodiment are denoted by the same reference numerals, and detailed description (including common operation) thereof is omitted as appropriate.

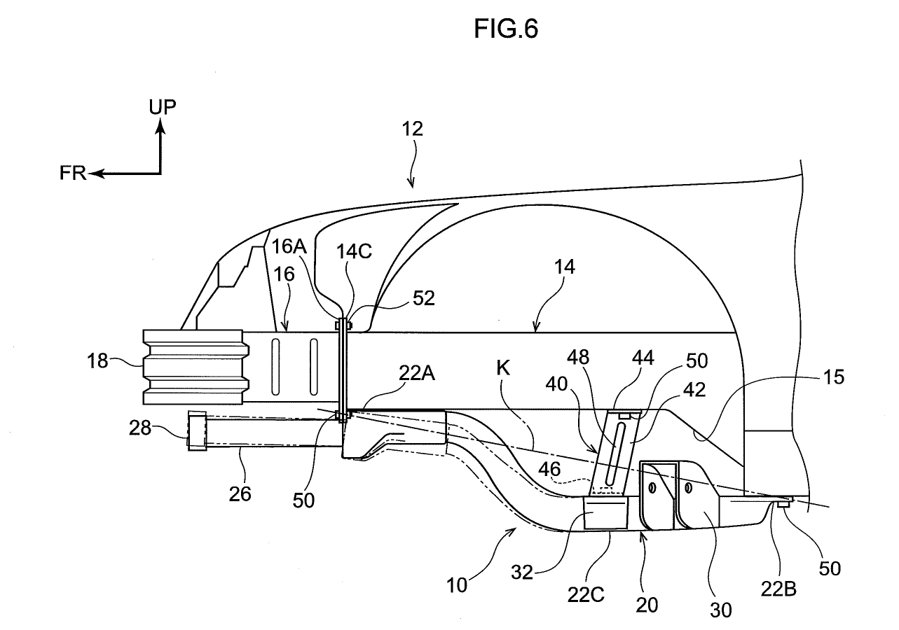

As shown in FIG. 6, in the vehicle front portion structure 10 relating to the second embodiment, in a side view that is seen from the vehicle transverse direction, the main body portion 42 of the connecting member 40 is formed in a shape that extends along a direction substantially orthogonal to the imaginary straight line K that connects the front side fixed portion 22A and the rear side fixed portion 22B of the side frame 22. Namely, as seen in a side view, the main body portion 42 of the connecting member 40 is disposed along the orientation of the vibration that is excited at the side frame 22 (the suspension member 20).

Accordingly, even if load is inputted directly to the mount supporting portion 32 via the engine mount 34 due to the engine 36 vibrating, vibration in the substantially vertical direction (the direction substantially orthogonal to the imaginary straight line K as seen in a side view), that is excited at the side frame 22 (the suspension member 20), can be suppressed effectively.

Note that, in the case of the second embodiment, because the main body portion 42 of the connecting member 40 is disposed along a direction substantially orthogonal to the imaginary straight line K as seen in a side view, vibration can be suppressed effectively even if the bead portion 48 that runs along that direction (the direction in which the main body portion 42 extends) is not formed. However, as shown in FIG. 6, the bead portion 48 that runs along that direction may be formed at the main body portion 42 so as to reinforce the main body portion 42.

The vehicle front portion structures 10 relating to the present embodiments have been described above on the basis of the drawings, but the vehicle front portion structures 10 relating to the present embodiments are not limited to the illustrated structures, and the designs thereof can be changed appropriately within a scope that does not depart from the gist of the present invention. For example, the lower connecting portion 46 of the connecting member 40 is not limited to a structure that is fastened by bolts (fastened together) together with the engine mount 34.

Further, the present embodiments are not limited to a structure in which only the illustrated one bead portion 48 is formed at the main body portion 42 of the connecting member 40, and may be structured such that plural bead portions 48 are formed along a direction substantially orthogonal to the imaginary straight line K as seen in side view. Moreover, the bead portion 48 does not have to be formed at the main body portion 42, provided that the rigidity and strength of the connecting member 40 are sufficiently ensured.

Further, the bead portion 48 and the main body portion 42 do not have to be provided along a direction substantially orthogonal to the imaginary straight line K as seen in side view, provided that vibration in the substantially vertical direction, that is excited at the side frame 22 (the suspension member 20) can be suppressed effectively. Further, it suffices for the sub-frame relating to the present invention to be a frame that supports at least the engine 36, but the sub-frame is not limited to the suspension member 20.

What is claimed is:

1. A vehicle front portion structure comprising:
front side members that are disposed along a vehicle body longitudinal direction, and whose vehicle body front portion sides are disposed at a higher position than vehicle body rear portion sides thereof;
a sub-frame that is disposed at a vehicle body lower side of the front side members at the vehicle body front portion sides of the front side members, due to front side fixed portions of the sub-frame being mounted to the vehicle body front portion sides of the front side members, and rear side fixed portions of the sub-frame being mounted to the vehicle body rear portion sides of the front side members;
mount supporting portions that are provided at midway portions in the vehicle body longitudinal direction of the sub-frame, and to which engine mounts that support an engine are mounted; and
connecting members that connect the mount supporting portions with the front side members.

2. The vehicle front portion structure of claim 1, wherein, in a side view seen from a vehicle transverse direction, each connecting member extends along a direction orthogonal to an imaginary straight line that connects the front side fixed portions and the rear side fixed portions.

3. The vehicle front portion structure of claim 1, wherein the each connecting member includes a main body portion that is formed in a flat plate shape, and a bead portion that is convex in cross-section is formed at the main body portion.

4. The vehicle front portion structure of claim 3, wherein, in a side view seen from a vehicle transverse direction, the bead portion extends along a direction orthogonal to an imaginary straight line that connects the front side fixed portion and the rear side fixed portion.
